(19) United States
(12) Patent Application Publication
(10) Pub. No.: US 2026/0054635 A1
(43) Pub. Date: Feb. 26, 2026

(54) HEADLIGHT FOR A MOTOR VEHICLE, MOTOR VEHICLE COMPRISING THE HEADLIGHT, METHOD FOR OPERATING THE HEADLIGHT

(71) Applicant: Dr. Ing. h.c. F. Porsche Aktiengesellschaft, Stuttgart (DE)

(72) Inventor: Philipp BOLAY, Flacht (DE)

(21) Appl. No.: 19/296,979

(22) Filed: Aug. 12, 2025

(30) Foreign Application Priority Data
Aug. 21, 2024 (DE) 10 2024 123 908.5

(51) Int. Cl. B60Q 1/08; B60Q 1/00; B60Q 1/068

(52) U.S. Cl. CPC B60Q 1/085; B60Q 1/0023; B60Q 1/068; B60Q 2200/30

(57) ABSTRACT

A headlight is provided for a motor vehicle. The headlight includes: a light module, which includes a cornering light or illuminated lettering; an environment sensing element, which includes an optical environment sensor, a radar, or a camera; a housing; and a changing device. The housing has a region into which the light module or the environment sensing element is displaceable, and the changing device is configured to carry out a change between the light module and the environment sensing element in the region.

### CROSS REFERENCE TO RELATED APPLICATIONS

This application claims benefit to German Patent Application No. DE 10 2024 123 908.5, filed on Aug. 21, 2024, which is hereby incorporated by reference herein.

### FIELD

The present disclosure relates to a headlight for a motor vehicle, a motor vehicle comprising the headlight, and a method for operating the headlight.

### BACKGROUND

Automotive lighting devices, such as headlights, are typically installed on a motor vehicle. DE 202018102945 U1 discloses an exemplary headlight for a motor vehicle.

### SUMMARY

In an embodiment, the present disclosure provides a headlight that is for a motor vehicle. The headlight includes: a light module, which includes a cornering light or illuminated lettering; an environment sensing element, which includes an optical environment sensor, a radar, or a camera; a housing; and a changing device. The housing has a region into which the light module or the environment sensing element is displaceable, and the changing device is configured to carry out a change between the light module and the environment sensing element in the region

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic illustration of a headlight in a first perspective view according to an embodiment of the present disclosure;

FIG. 2 a schematic illustration of the headlight in a second perspective view according to an embodiment of the present disclosure;

FIG. 3 a section through the headlight with a functional block in the headlight according to an embodiment of the present disclosure; and

FIG. 4 a section through the headlight with the functional block outside the headlight according to an embodiment of the present disclosure.

### DETAILED DESCRIPTION

According to an aspect of the present disclosure, a headlight is provided for a motor vehicle that includes a light module, which may be in particular embodiments a cornering light or an illuminated lettering, and an environment sensing element, which may be in particular embodiments an optical environment sensor, a radar, or a camera. The headlight may include a housing. The headlight may include, in the housing, a region into which the light module or the environment sensing element can be displaced. The headlight may include a changing device, wherein a change between the light module and the environment sensing element can be carried out with the changing device in this region. The environment sensing element can be displaced into the headlight instead of the light module, as needed. Otherwise, the environment sensing module is invisible in the headlight. For example, at night, the cornering light module can be activated and, during automated driving, can be switched to the environment sensing element, which is then in the same position.

In preferred embodiments, the changing device comprises a changing arm, wherein a guide axis is arranged on the housing, wherein the light module and the environment sensing element are arranged on different sides of the guide axis on the changing arm, wherein the changing arm can be moved in a rotatable manner about the guide axis from a first position into a second position, wherein the changing arm is arranged on the guide axis so as to be movable in a translatory manner, wherein the changing arm is arranged outside the housing, wherein the housing comprises a cut-out, wherein the light module can be moved into the housing or out of the housing through the cut-out in the first position of the changing arm by way of translatory movement of the changing arm, wherein, in the second position of the changing arm, the environment sensing element can be moved into the housing or out of the housing through the cut-out by way of translatory movement of the changing arm. The light module and the environment sensing element are functional blocks, which can be arranged with changing arms at different angles on the housing, depending on the available design space.

In preferred embodiments, the light module and the environment sensing element are arranged at opposite ends of the changing arm. This means that the functional blocks are arranged below 180° on the changing arm.

To perform the translatory movement, in preferred embodiments, the headlight comprises a movement piece, wherein the movement piece is supported so as to be moved in a translatory manner on the guide axis, wherein the movement piece is configured so as to move the changing arm in a translatory manner in relation to the housing upon a translatory movement of the movement piece.

In preferred embodiments, the headlight comprises a drive for moving the movement piece in a translatory manner. That is to say, the headlight represents an assembly comprising the translatory drive.

For example, the drive provides for the translatory movement of the movement piece in that the movement piece is arranged in a rotatably movable manner on the guide axis, wherein the movement piece comprises an external threaded spindle extending along the guide axis, wherein the housing comprises an internal thread, wherein the external threaded spindle engages with the internal thread, wherein a motor having a drive pinion is arranged on the changing arm, wherein the movement piece comprises a pinion that can be driven by the drive pinion for the rotational movement of the movement piece on the guide axis.

To perform the rotational movement, in a preferred embodiment, the headlight comprises a drive for rotational movement of the guide axis in relation to the housing. That is to say, the headlight represents an assembly comprising the rotary drive.

For example, the drive for the rotational movement of the guide axis on the housing provides that a motor is arranged with a drive pinion, wherein the guide axis comprises a pinion that can be driven by the drive pinion for the rotational movement of the guide axis.

For example, the guide axis supports the changing arm via a bearing.

For example, the housing receives the guide axis via a guide.

A motor vehicle can be provided, which comprises the headlight.

A method for operating the headlight provides that a change between the light module and the environment sensing element in the region is carried out with the changing device.

The method can provide that, in the first position of the changing arm, the light module is moved through the cut-out out of the housing by way of a translatory movement of the changing arm, wherein the changing arm is rotatably moved about the guide axis from the first position into the second position, wherein, in the second position of the changing arm, the environment sensing element is moved into the housing through the cut-out by way of a translatory movement of the changing arm or that, in the second position of the changing arm, the environment sensing element is moved out of the housing through the cut-out by way of a translatory movement of the changing arm, wherein the changing arm is rotatably moved about the guide axis from the second position into the first position, wherein, in the first position of the changing arm, the light module is moved into the housing through the cut-out by way of a translatory movement of the changing arm.

Further advantageous embodiments will emerge from the following description and the drawings.

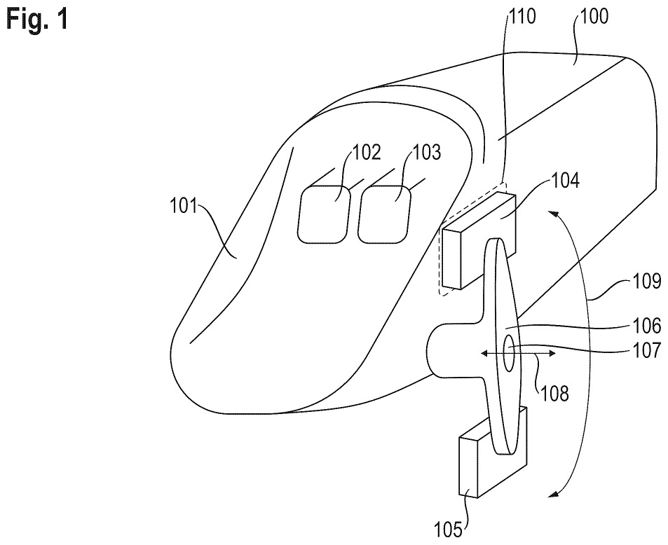

In FIG. 1, a headlight 100 is shown in a first perspective view. The headlight 100 comprises a housing 101. An ascent light module 102 and a main light module 103 are arranged in the housing 101.

The headlight 100 comprises a light module 104.

The headlight 100 comprises an environment sensing element 105.

The headlight 100 comprises a changing arm 106.

The headlight 100 comprises a guide axis 107.

The light module 104 is arranged on one side of the guide axis 107 on the changing arm 106. The environment sensing element 105 is arranged on another side of the guide axis 107 on the changing arm 106. For example, the light module 104 and the environment sensing element 105 are arranged at opposite ends of the changing arm 106. In the example, the ends of the changing arm 106 at which the light module 104 and the environment sensing element 105 are arranged at a 180° angle. An arrangement at an angle other than 180° can be provided. For example, the ends are arranged at an angle between 25° and 155°.

The light module 104 comprises, for example, a cornering light module or an illuminated lettering.

The environment sensing element 105 comprises, for example, an optical environment sensor, radar, or camera.

The light module 104 and the environment sensing element 105 are examples of functional blocks that can be displaced into the housing 101. More than two functional blocks can be provided, which can be displaced into the housing 101. More than two ends of the changing arm 106 can be provided, on each of which is arranged a functional block that can be displaced into the housing 101.

The changing arm 106 is guided through the guide axis 107. The changing arm 106 can be guided through the guide axis 107 in a translatory manner, i.e., in the direction 108 in which the guide axis 107 extends. The changing arm 106 can be moved in a rotatable manner while being guided through the guide axis 107 in a direction of rotation 109 about the guide axis 107.

The housing 101 comprises a cut-out 110. The cut-out 110 represents an opening in the housing 101, through which the respective functional block, i.e., the environment sensing element 105 or the light module 104, can be displaced into the housing 101 or out of the housing 101 by way of a translatory movement.

The changing arm 106 can be moved in a rotatable manner into a first position in which the light module 104 can be displaced in a translatory manner into the housing 101 through the cut-out 110.

The changing arm 106 can be moved in a rotatable manner into a second position, in which the environment sensing element 105 can be displaced in a translatory manner into the housing 101 through the cut-out 110.

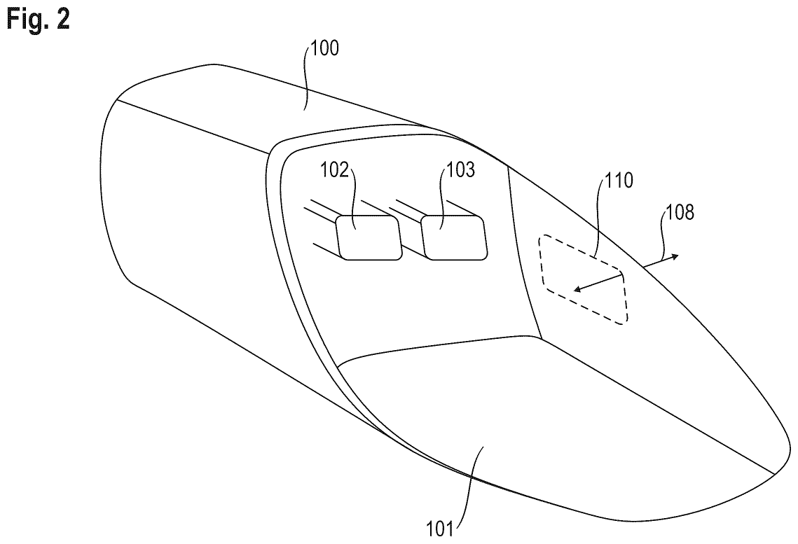

FIG. 2 shows a schematic illustration of the headlight 100 in a second perspective view. In the second perspective illustration, no functional block is arranged in the housing 101.

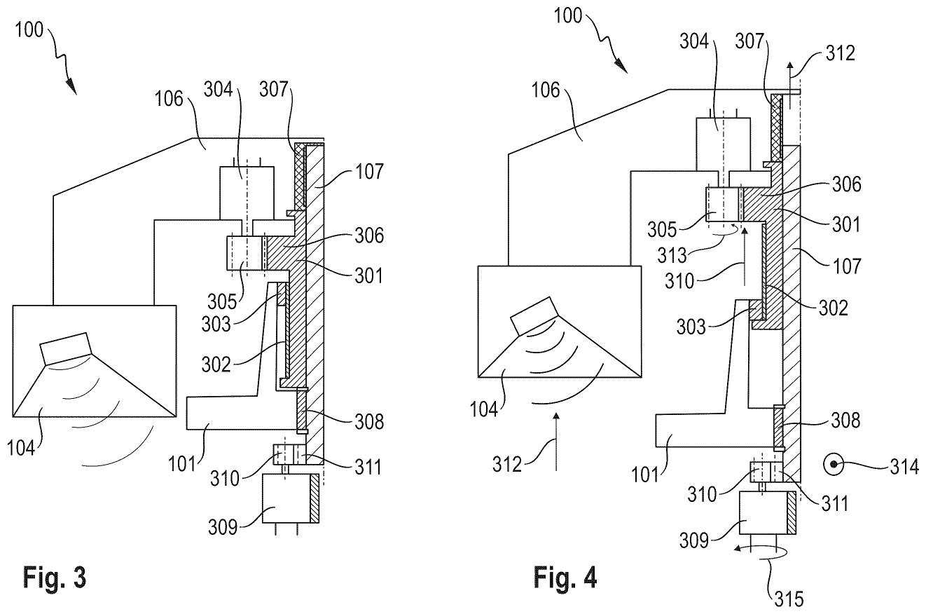

In FIG. 3, a section through the headlight 100 is shown with a functional block, in the example with the light module 104, in the headlight 100, i.e., in the housing 101.

The headlight 100 comprises a movement piece 302.

The headlight 100 comprises a drive for moving the movement piece 302 in a translatory manner.

FIG. 3 shows an example of the drive for moving the movement piece 302 in a translatory manner.

The movement piece 302 is arranged rotatably on the guide axis 107.

The movement piece 302 comprises an external threaded spindle 302 extending along the guide axis 107.

The housing 101 comprises an internal thread 303.

The external threaded spindle 302 engages with the internal thread 303.

A motor 304 having a drive pinion 305 is arranged on the changing arm 106.

The movement piece 301 comprises a pinion 306 that can be driven by the drive pinion 305 for the rotational movement of the movement piece 301 on the guide axis 107.

The guide axis 107 supports the changing arm 106, for example via a bearing 307.

The housing 101 receives the guide axis 107, for example via a guide 308.

The headlight 100 comprises a drive for moving the guide axis 107 in a rotatable manner in relation to the housing 101.

FIG. 3 shows an example of the drive for rotational movement of the movement piece 302.

For example, the drive for rotational movement of the guide axis 107 on the housing 101 provides that a motor 309 is arranged with a drive pinion 305.

For example, the drive for the rotational movement of the guide axis 107 on the housing 101 provides that the guide axis 107 comprises a pinion 311 that can be driven by the drive pinion 310 for the rotational movement of the guide axis 107.

In FIG. 4, a section through the headlight 100 with the light module 104 outside the headlight 100, i.e., outside the housing 101, is shown.

A method for operating the headlight 100 is described, with reference to FIGS. 3 and 4.

The method provides that a change between the light module 104 and the environment sensing element 105 in the region of the headlight 100, i.e., in the housing 101, is carried out with the changing device.

FIG. 3 and FIG. 4 show the changing arm 106 in the first position.

The method provides that, in the first position of the changing arm 106, the light module 104 is moved out of the housing 101 through the cut-out 110 by way of a translatory movement 312 of the changing arm 106. The translatory movement 312 is accomplished by rotating the motor 304 arranged on the changing arm 106 in a direction of rotation 313.

The method provides that the changing arm 106 is subsequently moved rotationally about the guide axis 107, i.e., by a rotational movement 314 from the first position into the second position. The rotational movement 314 is accomplished by rotating the motor 309 arranged on the housing 101 in a direction of rotation 315.

The method provides that, in the second position of the changing arm 106, the environment sensing element 105 is subsequently moved into the housing 101 through the cut-out 110 by way of a translatory movement of the changing arm 106.

The translatory movement 312 is accomplished by rotating the motor 304 arranged on the changing arm 106 counter to the direction of rotation 313.

For the displacement of the environment sensing element 105 out of the housing 101 and the displacement of the light module 104 into the housing 101, proceed accordingly.

That is to say, in the second position of the changing arm 106, the environment sensing element 105 is moved out of the housing 101 through the cut-out 110 by way of a translatory movement of the changing arm 106. The changing arm 106 is subsequently rotated about the guide axis 107 from the second position into the first position. Subsequently, in the first position of the changing arm 106, the light module 104 is moved into the housing 101 through the cut-out 110 by way of a translatory movement of the changing arm 106.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A headlight for a motor vehicle, the headlight comprising:
a light module, which comprises a cornering light or illuminated lettering;
an environment sensing element, which comprises an optical environment sensor, a radar, or a camera;
a housing; and
a changing device,
wherein the housing comprises a region into which the light module or the environment sensing element is displaceable, and
wherein the changing device is configured to carry out a change between the light module and the environment sensing element in the region.

2. The headlight according to claim 1,
wherein the changing device comprises a changing arm,
wherein a guide axis is arranged on the housing,
wherein the light module and the environment sensing element are arranged on different sides of the guide axis on the changing arm,
wherein the changing arm is configured to be moved rotatably about the guide axis from a first position into a second position,
wherein the changing arm is arranged on the guide axis so as to be movable translationally,
wherein the changing arm is arranged outside the housing,
wherein the housing comprises a cut-out,
wherein the light module is configured to be moved into the housing or out of the housing through the cut-out in the first position of the changing arm by way of translatory movement of the changing arm, and
wherein, in the second position of the changing arm, the environment sensing element is moveable into the housing or out of the housing through the cut-out by way of translatory movement of the changing arm.

3. The headlight according to claim 2, wherein the light module and the environment sensing element are arranged on opposite ends of the changing arm.

4. The headlight according to claim 2,
wherein the headlight further comprises a movement piece,
wherein the movement piece is supported on the guide axis so as to be movable translationally, and
wherein the movement piece is configured so as to move the changing arm translationally in relation to the housing upon a translatory movement of the movement piece.

5. The headlight according to claim 4, wherein the headlight comprises a drive for moving the movement piece translationally.

6. The headlight according to claim 5,
wherein the drive provides for translatory movement of the movement piece in that the movement piece is arranged in a rotatably movable manner on the guide axis,
wherein the movement piece comprises an external threaded spindle extending along the guide axis,
wherein the housing comprises an internal thread,
wherein the external threaded spindle engages with the internal thread,
wherein a motor comprising a drive pinion is arranged on the changing arm, and
wherein the movement piece comprises a pinion that is driveable by the drive pinion to provide the rotational movement of the movement piece on the guide axis.

7. The headlight according to claim 2, wherein the headlight comprises a drive that is configured to provide rotational movement of the guide axis in relation to the housing.

8. The headlight according to claim 7,
wherein the drive is configured to provide the rotational movement of the guide axis on the housing,
wherein a motor is arranged with a drive pinion, and
wherein the guide axis comprises a pinion that is driveable by the drive pinion for the rotational movement of the guide axis.

9. The headlight according to claim 2, wherein the guide axis supports the changing arm via a bearing.

10. The headlight according to claim 2, wherein the housing receives the guide axis via a guide.

11. A motor vehicle, wherein the motor vehicle comprises the headlight according to claim 1.

12. A method for operating the headlight configured according to claim 1, the method comprising changing between the light module and the environment sensing element with the changing device in the region.

13. A method for operating the headlight configured according to claim 2, the method comprising: changing between the light module and the environment sensing element with the changing device in the region by:
in the first position of the changing arm, moving the light module through the cut-out out of the housing by way of translatory movement of the changing arm, rotatably moving the changing arm about the guide axis from the first position into the second position, and moving, in the second position of the changing arm, the environment sensing element into the housing through the cut-out by way of translatory movement of the changing arm; or
moving, in the second position of the changing arm, the environment sensing element out of the housing through the cut-out by way of translatory movement of the changing arm, rotatably moving the changing arm about the guide axis from the second position into the first position, and moving, in the first position of the changing arm, the light module into the housing through the cut-out by way of translatory movement of the changing arm.
